(19) United States
(12) Patent Application Publication
(10) Pub. No.: US 2006/0234580 A1
(43) Pub. Date: Oct. 19, 2006

(54) Hot melt adhesives with exceptional wet strength in hot soapy aqueous media

(76) Inventor: Andres I. Sustic, Woodbury, MN (US)

Correspondence Address: H.B. FULLER COMPANY, 1200 WILLOW LAKE BLVD., P.O. BOX 64683, ST. PAUL, MN, 55164-0683, US

(21) Appl. No.: 11/108,232

(22) Filed: Apr. 18, 2005

(51) Int. Cl. B32B 27/04; B32B 5/02; B32B 27/12

(52) U.S. Cl. 442/149; 442/150

(57) ABSTRACT

The invention relates to a hot melt adhesive composition including a blend of a first styrene-isoprene-styrene block copolymer having about 15% by weight styrene and about 42% by weight styrene-isoprene diblock and a second styrene-isoprene-styrene block copolymer having about 30% by weight styrene and substantially 0% by weight styrene-isoprene diblock, a solid plasticizer, a liquid plasticizer, and a tackifying resin. The adhesive composition is resistant to debonding induced by an aqueous soapy medium at about 140° F. and useful for preparing laminates

### TECHNICAL FIELD

The invention relates to a hot melt adhesive composition including a blend of two specific styrenic block copolymers. The adhesive exhibits very good wet strength against hot soapy aqueous media.

### SUMMARY OF THE INVENTION

In one aspect, the invention features a hot melt adhesive composition including a blend of a first styrene-isoprene-styrene (SIS) block copolymer having about 15% by weight styrene and about 42% by weight styrene-isoprene diblock and a second styrene-isoprene-styrene (SIS) block copolymer having about 30% by weight styrene and substantially 0%, i.e., less than about 1% by weight styrene-isoprene diblock; a solid plasticizer; a liquid plasticizer; and a tackifying resin. The composition has a total styrene-isoprene diblock content of from about 10% by weight to about 20% by weight, based on the total weight of the first and second block copolymers. The composition exhibits resistance to de-bonding induced by an aqueous soapy medium at a temperature of from ambient to 140° F.

In another aspect, the invention features an article that includes a first substrate, a second substrate and the adhesive composition of the invention sandwiched between the first and the second substrates. The article is resistant to de-bonding induced by an aqueous soapy medium at a temperature of from ambient to about 140° F.

In yet another aspect, the invention features a method of resisting de-bonding induced by an aqueous soapy medium. The method includes using an article bonded by the adhesive composition of the invention in an aqueous soapy medium at a temperature of from ambient to about 140° F.

The adhesive composition of the invention exhibits a storage modulus (G′) at 50° C. of no greater than about 10×10⁶ dyn/cm². In some embodiments, the composition exhibits a storage modulus (G′) at 50° C. of no greater than about 5×10⁶ dyn/cm², or no greater than about 4×10⁶ dyn/cm². In some embodiments, the composition exhibits a storage modulus (G′) at 50° C. of no less than about 1×10⁶ dyn/cm².

The adhesive composition of the invention has a melt viscosity of no greater than about 6,000 cps at 300° F. and no less than about 3000 cps at 300° F.

The adhesive composition of the invention exhibits high heat resistance, excellent adhesive property for bonding different substrates such as non woven-to-non woven, non woven-to-polyethylene film, non woven-to-tissue paper, laminate-to-laminate, or other substrates used in infant care, personal hygiene and household products.

Particularly, the adhesives composition of the invention exhibits very good resistance to wet environment, e.g., when being submerged in an aqueous medium, at a temperature of from ambient to about 140° F. (about 60° C.) whether in the absence or presence of tensioactive substances. Tensioactive substances, e.g., soaps or detergents help to lower the surface tension of water, thereby increasing the water's wetting effect. In one embodiment, the adhesive composition exhibits very good wet strength measured by resistance to delamination after soaking in a soapy media at about 140° F. for at least 30 seconds.

### DETAILED DESCRIPTION OF THE INVENTION

The hot melt adhesive composition of the invention includes a blend of a first styrene-isoprene-styrene block copolymer and a second styrene-isoprene-styrene block copolymer, a solid plasticizer, a liquid plasticizer, and a tackifying resin.

The first styrene-isoprene-styrene block copolymer has about 15% by weight styrene and about 42% by weight styrene-isoprene di-block. It has a MFR (ASTM D-1238), of 25 g/10 min.

The second styrene-isoprene-styrene block copolymer has about 30% by weight styrene and 0% by weight styrene-isoprene di-block, i.e., it is a linear, substantially pure triblock copolymer. It has a MFR of 12 g/10 min.

The first and second block copolymers are mixed at a weight ratio of from about 3 to about 1 (3:1) to about 1 to about 3 (1:3), or from about 2 to about 1 (2:1) to about 1 to about 2 (1:2), or from about 1 to about 1 (1:1) to about 1 to about 1.67 (1:1.67).

Examples of commercially available styrene-isoprene-styrene block copolymers include Vector 4114 [from Dexco Polymers LP, a limited partnership of affiliates of the Dow Chemical Company and ExxonMobil Chemical Company, which produces both SIS and SBS from its dedicated facilities in Plaquemine, La.)], SOL TE-9131 (Polimeri Europa, formerly Europrene), and Vector 4211, Kraton D-1164 from Kraton Polymers (Belpre, Ohio or Paulinia, Brazil); or TPE 2411 from Taipol (TSRC Corp., Taiwan)].

Other commercially available styrene-isoprene-styrene block copolymers, applicable in the invention, either in combination with another styrene-isoprene-styrene block copolymer or by itself, include, e.g., SOL T-193B, Kraton D-1193, D-1163 BT, or RP-6430.

The blend of the first and second block copolymers is present in the composition from about 18% by weight to about 31% by weight, or from about 20% to 29% by weight, or from about 22% to 26% by weight, based on the total weight of the composition.

A plasticizer is broadly defined as a typically organic composition that can be added to rubbers and other resins to improve extrudability, flexibility, workability or stretchability. The selection of plasticizer and the use of small amounts of oil can aid in the control over the time from spraying to solidification.

Useful plasticizers include an aromatic carboxylic acid ester of a polyfunctional alcohol having 1 to 10 hydroxyl groups. Polyfunctional alcohols that can be used in the compositions of this class of plasticizers include compounds having at least two hydroxyl groups and at least two carbon atoms in the molecule. Aromatic acids that can be used with the polyfunctional alcohols to form these class ester plasticizer compounds of the invention include aromatic carboxylic acids, typically having at least one aromatic group and at least one carboxyl function. Representative acids include benzoic acid, naphthanoic acid and 4-methyl benzoic acid.

Examples of plasticizers include such as cycloaliphatic alkanol ester of an aromatic carboxylic acid, naphthenic oil, and mixtures thereof. In one embodiment, the solid plasticizer cycloaliphatic alkanol ester of an aromatic carboxylic acid is cyclohexane dimethanol dibenzoate, e.g., 1,4-cyclohexane dimethanol dibenzoate. Examples of commercially available plasticizers include e.g., Benzoflex 352 (Velsicol Chemical Corp., Northbrook, Ill.), CALSOL 5555 (Calumet Lubricants Co., Burnham, Ill.), or Nyflex 222B (Nynas Naphthenics, Stockholm, Sweden).

The solid plasticizer is present in the composition in an amount of from about 14% by weight to about 20% by weight, based on the total weight of the composition. The liquid plasticizer is present in an amount of from about 4% by weight to about 8% by weight, based on the total weight of the composition.

Useful tackifying resins include rosin derivatives such as wood rosin, tall oil tall oil derivatives, rosin ester resins, natural and synthetic terpenes, aromatic resins e.g., aromatic modified dicyclodipentadienyl resins, aliphatic resins including hydrogenated synthetic C9 resins, synthetic branched and unbranched C5 resins, e.g., hydrogenated dicyclodipentadienyl resins, mixed aromatic-aliphatic resins, and mixtures thereof. Other tackying resins such as those derived from alpha-methyl styrene monomer can also be used.

Examples of commercially available tackifying resins include Escorez 5400 and 5600 from ExxonMobil Chemical (Houston, Tex.), Sylvares ZT105LT from Arizona Chemical (Jacksonville, Fla.), Eastotac H-1000W from Eastman Chemical Co. (Kingsport, Tenn.), Sukorez SU 200 and SU 400 from Kolon Chemical Co. (Kwachon City, Korea), and Arkon P100 and M100 from Arakawa Chemical Industries (Osaka, Japan).

Tackifying resin is present in the composition in an amount of from about 45% by weight to about 55% by weight, based on the total weight of the composition.

The adhesive composition of the invention may further include other additives such as anti blocking/slip modifier(s), antioxidant(s), etc. The adhesive composition may further include other polymer(s) such as, Zeropack film material [a linear low density polyethylene (LLDPE)], in an amount of up to about 1% by weight, based on the total weight of the composition.

In another aspect, the invention features an article that includes a first substrate, a second substrate and the adhesive composition of the invention sandwiched between the first and the second substrates. The article is resistant to de-bonding induced by an aqueous soapy medium at a temperature of from ambient temperature to about 140° F.

The first and second substrates may be the same or different substrate materials. In some embodiments, the first and second substrates include nonwoven fabrics, thermoplastic textured films such as polyethylene, polypropylene, polyester, etc., tissue, paper, laminates made of cellulose and cellulose/Nonwoven composites, as well as typical substrates used in infant care, personal hygiene and household products.

The adhesive composition of the invention can be applied to a substrate using any conventional methods. In some embodiments, the adhesive composition is applied using a controlled fiberization method e.g., spiral spray or swirl spray. The adhesive composition can be applied to a substrate at a coat weight of from about 1 gram/m² to about 100 gram/m², preferably from about 10 gram/m² to about 40 gram/m².

Other hot melt adhesive application methods include, e.g., melt blown.

In yet another aspect, the invention features a method of resisting de-bonding induced by an aqueous soapy medium. The method includes using an article bonded by the adhesive composition of the invention in an aqueous soapy medium at a temperature from about ambient temperature to about 140° F. In one embodiment, the article exhibits substrate failure after soaking in an aqueous soapy media at about 140° F. for about 30 seconds.

The aqueous soapy medium can be any aqueous soapy medium used for, e.g., household cleaning, clean-surface preparation, such as metal sheets, etc. “Aqueous soapy medium” refers to an aqueous medium including any kind of detergent(s), soap(s), or similar tensioactive substance(s). The concentration of the soap varies depending on the end use. In some embodiments, the concentration of the soap can be as high as about 3% by weight, based on the total weight of the medium. In other embodiments, the concentration can be as low as about 0.1% to about 0.2% by weight.

The invention is further illustrated by the following examples that should not be construed to limit the scope of the present invention.

### EXAMPLES

Test Methods

Wet Strength

Wet strength of an adhesive composition is measured as follows:

An adhesive is applied onto a first substrate (Composite Fabric with DuraHex pockets) by spiral spraying (or swirl spraying) at the temperatures and the coat weights indicated in Tables II. A second substrate (2-ply perforated tissue roll) is then combined with the coated first substrate. After allowing the sample to age for at least 24 hours at ambient temperature, five (5) to seven (7) one-inch strips of the sample laminates are cut for wet strength testing.

A thermo-container is filled with hot water at about 140° F., to which about 1 wt % of GOJO All purpose skin cleaner is added. Then, the one-inch wide strips are submerged into the hot soapy water and agitated with a spoon for at least 30 seconds. Thereafter, the specimens are withdrawn from the container, and immediately manually peeled in a 180° peel mode. The mode of failure is observed and reported as either “substrate failure” indicating strong wet strength, or “delaminated” indicating poor wet strength.

Melt Viscosity

Melt viscosity is measured according to the ASTM test Method D-3256, using a Brookfield Viscometer Model RV DV II+, with a spindle #27 at the temperatures indicated in Table II.

Mettler Softening Point

Softening point is measured using a Mettler Toledo (Columbus, Ohio), FP83HT Dropping Point Cell at a heating rate of 3.6° F./min.

Dynamic Mechanical Analysis

Dynamic Mechanical Analysis is carried out using an RDA rheometer from TA Instruments (New Castle, Del. An H. B. Fuller internal test method is used whereby samples are scanned in a temperature ramp mode at 3° C./min and at a frequency of 10 rad/sec.

### Comparative Example 1

An adhesive composition is prepared by combining ingredients according to Table I. The wet strength and other properties of the adhesive composition are tested according to the above test methods. The results are reported in Tables II and III.

### Comparative Example 2

An adhesive composition is prepared by combining ingredients according to Table I. The wet strength and other properties of the adhesive composition are tested according to the above test methods. The results are reported in Tables II and III.

### Example 1

An adhesive composition is prepared by combining ingredients according to Table I. The wet strength and other properties of the adhesive composition are tested according to the above test methods. The results are reported in Tables II and III.

TABLE I

| | Com. Ex. 1 | Com. Ex. 2 | Ex. 1 |
|---|---|---|---|
| Ingredients | (wt %) | (wt %) | (wt %) |
| Vector 4114 | 10.00 | — | 9.00 |
| Vector 4211 | — | 30.00 | 15.00 |
| Petrothene NA 420-000 (LLDPE) | 0.25 | 0.25 | 0.25 |
| Escorez 5400 | — | 19.10 | 9.55 |
| Escorez 5600 | 51.55 | 30.00 | 41.40 |
| Benzoflex 352 | 15.00 | 19.50 | 16.75 |
| Calsol 5555 | 13.00 | — | 6.50 |
| RM 6313 | 2.00 | 0.65 | 1.20 |
| Irganox 1010 | 0.200 | 0.5 | 0.35 |

### Comparative Example 3

An adhesive composition is prepared by combining ingredients according to Comparative Example 1 plus 2 wt % Endex 155 (tackifying resin). Various properties and the wet strength of the composition are reported in Tables II and III.

### Comparative Example 4

An adhesive composition is prepared by combining ingredients according to Comparative Example 2 plus 3 wt % Endex 155. Various properties and the wet strength of the composition are reported in Tables II and III.

### Comparative Example 5

An adhesive composition is prepared by combining ingredients according to Comparative Example 2 plus 10 wt % Calsol 5555 (liquid plasticizer). Various properties and the wet strength of the composition are reported in Tables II and III.

TABLE II

| | | Mettler | | | |
|---|---|---|---|---|---|
| | Melt | Softening | | Tan | |
| | Viscosity | Point | Tg, | Delta | G′ @˜50° C. |
| Adhesive | (27/20/30) | ° F. | ° C. | @Tg | (dyn/cm2) |
| Comparative | 2500 | 161 | 26 | 1.76 | 0.88 × 10⁶ |
| Example 1 | | | | | |
| Comparative | 9560 | 195 | 25 | 1.33 | 15.8 × 10⁶ |
| Example 2 | | | | | |
| Comparative | 1975 | 154 | 24.5 | 2.73 | 0.37 × 10⁶ |
| Example 3 | | | | | |
| Example 1 | 4375 | 184 | 25.6 | 1.47 | 2.5 × 10⁶ |
| Comparative | 8450 | 192 | <20 | Not | 8.87 × 10⁶ |
| Example 4 | | | | deter- | |
| | | | | mined | |
| Comparative | 4050 | 188 | <20 | Not | 5.0 × 10⁶ |
| Example 5 | | | | deter- | |
| | | | | mined | |

TABLE III

| | | Melt and Air | | | | |
|---|---|---|---|---|---|---|
| | Coat Weight, | Temperature, | Roll Nip | Wet Strenth at 140° F. | | |
| Adhesive | gsm | ° C. | Press., psi | Substrate 1 | Substrate 2 | Comments |
| Comparative | 10 | 300 and 350 | 20 | Delamination by | Delamination by | Adhesive residue was observed on |
| Example 1 | 25 | | | cohesive failure | cohesive failure | both sides of the laminate |
| Comparative | 10 | 330 and 350 | 20 | Failed by delam. | Failed by delam. | Very little residue left |
| Example 2 | 25 | | | Failed by delam. | Failed by delam. | On substrate 2 (the tissue) |
| Comparative | 10 | 351 and 400 | 20 | Failed by delam. | Failed by delam. | Very little residue left |
| Example 2 | 25 | | | Failed by delam. | Failed by delam. | On substrate 2 (the tissue) |
| Comparative | 10 | 330 and 350 | 20 | Delamination by | Delamination by | Adhesive residue was observed on |
| Example 3 | 25 | | | cohesive failure | cohesive failure | both sides of the laminate |
| Comparative | 10 | 347 and 350 | 20 | Delamination by | Delamination by | Adhesive residue was observed on |
| Example 3 | 25 | | | cohesive failure | cohesive failure | both sides of the laminate |
| Example 1 | 25 | 325 and 360 | 20 | Partial failure | Tissue failure | The adhesive bond held up while |
| | 25 | | 30 | Partial failure | Tissue failure | the tissue failed during the peel test |
| Example 1 | 25 | 351 and 400 | 20 | Tissue failure | Tissue failure | The adhesive bond held up while |
| | 25 | 351 and 400 | 30 | Tissue failure | Tissue failure | the tissue failed during the peel test |
| Comparative | 10 | 330 and 400 | 20 | Delamination | Delamination | Adhesive residue was observed on |
| Example 4 | 25 | | | Delamination | Delamination | both sides of the laminate |
| Comparative | 10 | 350 and 400 | 20 | Delamination | Delamination | Adhesive residue was observed on |
| Example 4 | 25 | | | Delamination | Delamination | both sides of the laminate |
| Comparative | 25 | 325 and 400 | 40 | Delamination | Delamination | Adhesive residue was observed on |
| Example 5 | 40 | | | Delamination | Delamination | both sides of the laminate |
| Comparative | 25 | 350 and 400 | 40 | Delamination | Delamination | Adhesive residue was observed on |
| Example 5 | 40 | | | Delamination | Delamination | both sides of the laminate |

NOTE:
All adhesives were applied by spiral spray mode (swirl spray)
Substrate 1.-Composite Fabric with DuraHex pockets;
Substrate 2.-2-ply Perofrated tissue roll

We claim:

1. A hot melt adhesive composition comprising:
a) a blend of styrenic block copolymer comprising
i) a first styrene-isoprene-styrene block copolymer that has about 15% by weight styrene and about 42% by weight styrene-isoprene diblock, and
ii) a second styrene-isoprene-styrene block copolymer that has about 30% by weight styrene and substantially 0% by weight styrene-isoprene diblock,
b) a solid plasticizer;
c) a liquid plasticizer; and
d) a tackifying resin,
wherein the total styrene-isoprene diblock content of the composition is from about 10% by weight to about 20% by weight, based on the total weight of the first and second block copolymers, and wherein the composition is resistant to debonding induced by an aqueous soapy medium at 140° F.

2. The composition of claim 1, wherein the first and second block copolymers are mixed in a weight ratio of from about 3 to about 1 (1:1) to about 1 to about 3.

3. The composition of claim 1, wherein the blend of the styrenic block polymer is present in the amount of from about 18% by weight to about 31% by weight, based on the total weight of the composition.

4. The composition of claim 1, wherein the tackifier used is selected from the group consisting of aromatic resins, aromatic-aliphatic resins, aliphatic resins, and mixtures thereof.

5. The composition of claim 4, wherein, the aliphatic resins comprise hydrogenated dicyclodipentadienyl resin.

6. The composition of claim 1, wherein the tackifying resin is an aromatic modified dicyclodipentadienyl resin.

7. The composition of claim 1, wherein the tackifying resin is present in the amount of from about 45% by weight to about 55% by weight, based on the total weight of the composition.

8. The composition of claim 1, wherein the solid plasticizer is present in an amount of from about 14% by weight to about 20% by weight, based on the total weight of the composition.

9. The composition of claim 1, wherein the liquid plasticizer is present in an amount of from about 4% by weight to about 8% by weight, based on the total weight of the composition.

10. The composition of claim 1, wherein the composition exhibits substrate failure when tested in an aqueous soapy medium at 140° F.

11. The composition of claim 1, wherein the composition exhibits a storage modulus G′ of less than 4×10⁶ at 50° C.

12. The composition of claim 1, wherein the composition exhibits a melt viscosity of no greater than about 6000 cps at 300° F.

13. The composition of claim 1, wherein the solid plasticizer is a cycloaliphatic alkanol ester of an aromatic carboxylic acid.

14. The composition of claim 1, wherein the liquid plasticizer is naphthenic oil.

15. An article comprising a first substrate, a second substrate and the adhesive composition of claim 1 sandwiched between the first and the second substrates, wherein the article is resistant to debonding in an aqueous soapy medium at a temperature of from about ambient to about 140° F.

16. The article of claim 15, wherein the first and the second substrates comprise polyethylene film, polypropylene film, polyester film, non-woven fabrics, tissue, paper, or laminates made of cellulose or cellulose/nonwoven composites.

17. A method of resisting debonding induced by an aqueous soapy media, comprising:
using an article bonded by the adhesive composition of claim 1 in the aqueous soapy media at a temperature from about ambient to about 140° F.
